(19) United States
(12) Patent Application Publication
(10) Pub. No.: US 2014/0154931 A1
(43) Pub. Date: Jun. 5, 2014

(54) Electrical Connector

(71) Applicants: Jianfeng Wu, Shanghai (CN); Zhenyu Chen, Shanghai (CN); Lihao Liu, Shanghai (CN); Yuanchun Chen, Shanghai (CN); Feirong Zhou, Shanghai (CN)

(72) Inventors: Jianfeng Wu, Shanghai (CN); Zhenyu Chen, Shanghai (CN); Lihao Liu, Shanghai (CN); Yuanchun Chen, Shanghai (CN); Feirong Zhou, Shanghai (CN)

(21) Appl. No.: 13/475,309

(22) Filed: May 18, 2012

(30) Foreign Application Priority Data
May 19, 2011 (CN) 201120166203.X

(51) Int. Cl. H01R 13/436

(52) U.S. Cl. CPC H01R 13/4367
USPC 439/752

(57) ABSTRACT

An electrical connector includes a housing, a first terminal, and a first lock. The housing includes a first receiving chamber and first recess positioned adjacent to the first receiving chamber. The first terminal is insertable into the first receiving chamber. The lock is securable to the housing and includes a horizontal base plate, a first pressing rod extending downward from the horizontal base plate and insertable into the first receiving chamber to press against the first terminal, and a first rotation prevention member extending downward from the horizontal base plate and insertable into the first recess to mate with the recess in a substantially gapless manner.

### CROSS-REFERENCE TO RELATED APPLICATION

This application claims priority under 35 U.S.C. §119 to Chinese Patent Application No. 201120166203.X filed on May 19, 2011.

### FIELD OF THE INVENTION

The invention relates to an electrical connector and, more particularly, to an electrical connector for transmitting electric power or an electrical signal.

### BACKGROUND

A known electrical connector generally includes a housing and a terminal disposed in the housing. A cable is inserted into the housing and electrically connected to the terminal. If the cable is pulled from the housing, the terminal may be loosened from the housing. Accordingly, it is necessary to firmly secure the terminal in the housing.

In order to firmly secure the terminal in the housing, a known lock has been developed. The known lock is snapped to the housing and press against an end of the terminal to prevent the terminal from being disengaged from the housing.

The cable is inserted into the housing through a cable passage formed in the lock device, however, the cables for the electrical connector may have different diameters. Accordingly, the cable passage of the known lock must be adapted to various cables with different diameters. Furthermore, the cable passage of the known lock has a constant diameter, and the constant diameter must be adapted for the cable having a largest diameter among the various cables.

When a cable having a smaller diameter is used to pass through the cable passage of the known lock device, there is a larger gap between the cable passage having the constant diameter and the cable having the smaller diameter. Accordingly, when the cable having the smaller diameter is pulled outward, the known lock may easily rotate or offset with respect to an axis of the cable passage and generate a larger moment of force on the known lock device. When the pulling force exerted on the known lock using the cable reaches a certain value, a locking piece of the lock snapped to the housing may be broken down. Once the known lock is damaged, the cable and the terminal may be loosened from the housing of the electrical connector when pulled, and the electrical connector may fail.

### SUMMARY

The invention has been made to overcome or alleviate at least one aspect of the above mentioned disadvantages.

An electrical connector, according to the invention, includes a housing, a first terminal, and a first lock. The housing includes a first receiving chamber and first recess positioned adjacent to the first receiving chamber. The first terminal is insertable into the first receiving chamber. The lock is securable to the housing and includes a horizontal base plate, a first pressing rod extending downward from the horizontal base plate and insertable into the first receiving chamber to press against the first terminal, and a first rotation prevention member extending downward from the horizontal base plate and insertable into the first recess to mate with the recess in a substantially gapless manner.

### BRIEF DESCRIPTION OF THE DRAWINGS

The above and other features of the invention will become more apparent by describing in detail illustrative embodiments thereof with reference to the accompanying drawings, in which:

FIG. 1 is a perspective view of a lock of an electrical connector according to the invention;

FIG. 2 is a perspective view of a housing that mates with the lock of the electrical connector shown in FIG. 1;

FIG. 3 is a perspective sectional view of the lock of FIG. 1 and the housing of FIG. 2 that are snapped together;

FIG. 4 is an enlarged sectional view of the housing and the lock that are snapped together, showing a terminal in the housing;

FIG. 5 is an enlarged sectional view showing a rotation prevention member of the lock mated with a recess of the housing; and

FIG. 6 is another enlarged sectional view of the rotation prevention in FIG. 5, showing how the rotation prevention member prevents the lock from being rotated outward.

### DETAILED DESCRIPTION OF THE EMBODIMENT(S)

Various embodiments of the disclosure will be described hereinafter in detail with reference to the attached drawings, wherein the like reference numerals refer to the like elements. The present disclosure may, however, be embodied in many different forms and should not be construed as being limited to the embodiment set forth herein; rather, these embodiments are provided so that the disclosure will be thorough and complete, and will fully convey the concept of the disclosure to those skilled in the art.

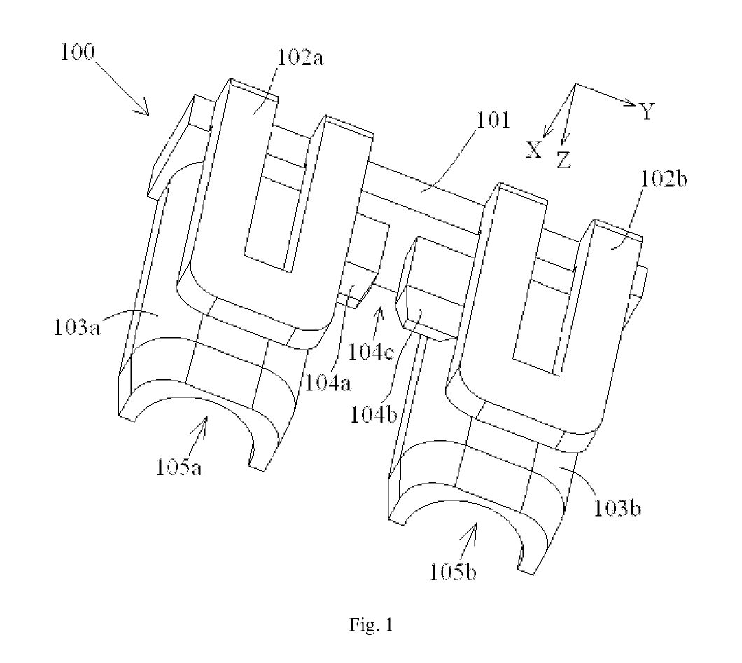

As shown in FIG. 1, a lock 100 generally includes a horizontal base plate 101, two pressing rods 103a, 103b, two locking pieces 102a, 102b, and two rotation prevention members 104a, 104b.

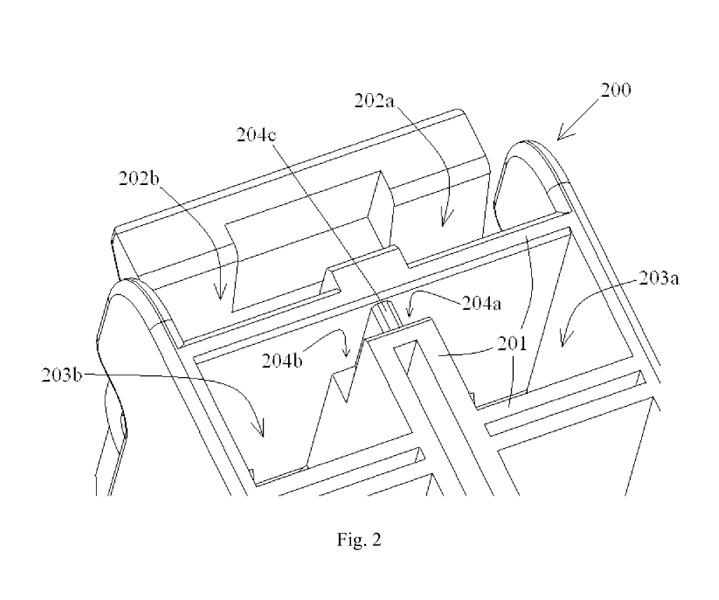

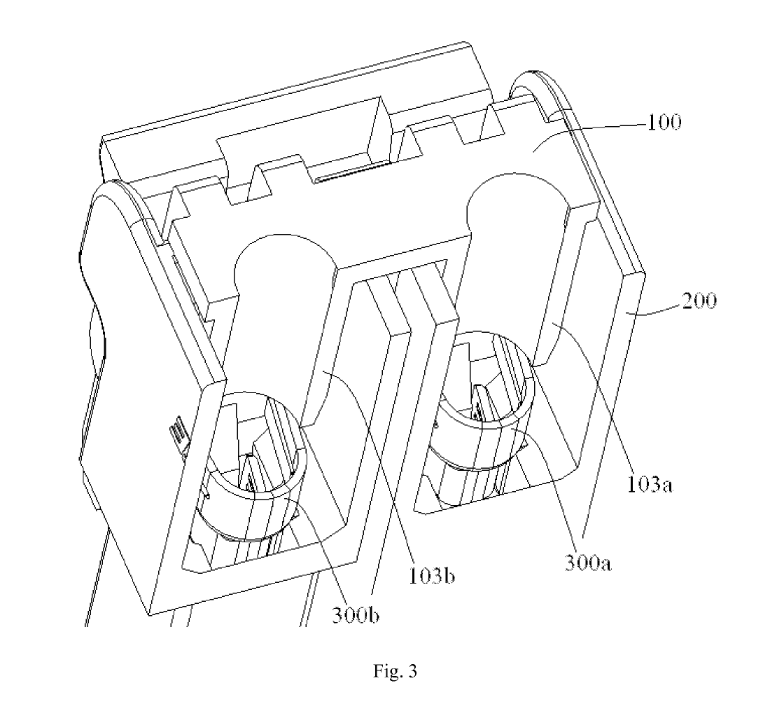

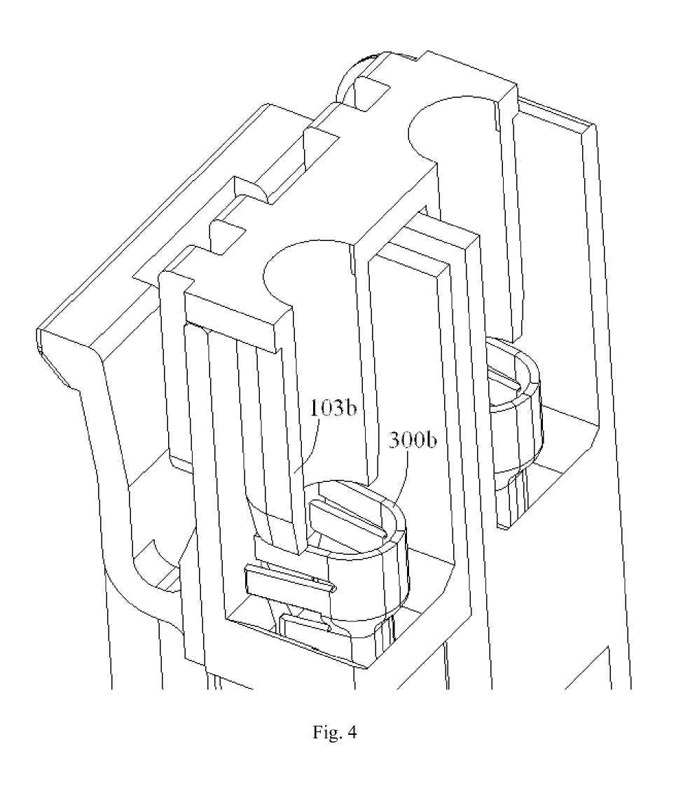

The horizontal base plate 101 extends in a longitudinal direction Y shown in FIG. 1. The two pressing rods 103a, 103b are integrally connected to the horizontal base plate 101 and extend downward in a substantially vertical direction Z shown in FIG. 1 from the horizontal base plate 101. The two pressing rods 103a, 103b are inserted into two receiving chambers 203a, 203b of the housing 200 shown in FIG. 2, respectively, and press against the respective terminals 300a, 300b (see FIGS. 3-4) to secure the terminals 300a, 300b in the housing 200.

In the shown embodiment, the pressing rods 103a, 103b have a semi-cylinder shape and each is formed with a semi-circular cable passage 105a, 105b through which a cable is introduced into the housing 200 and electrically connected with one terminal 300a or 300b. However, please be noted that the invention is not limited to this, the pressing rods 103a, 103b may be formed in other shapes, such as elliptic, rectangular, etc.

Referring to FIG. 1, the two locking pieces 102a, 102b are connected to the horizontal base plate 101 and extend downward in the vertical direction Z shown in FIG. 1 from the horizontal base plate 101. The two locking pieces 102a, 102b are snapped into two slots 202a, 202b of the housing 200 shown in FIG. 2, respectively.

As shown in FIG. 1, one pressing rod 103a and one locking piece 102a are arranged at one longitudinal side of the horizontal base plate 101 and separated from each other. The other pressing rod 103b and the other locking piece 102b are arranged at the other longitudinal side of the horizontal base plate 101 and separated from each other.

Please refer to FIG. 1, one rotation prevention member 104a is located between one pressing rod 103a and one locking piece 102a, while another rotation prevention member 104b is located between the other pressing rod 103b and the other locking piece 102b.

Although the lock 100 has two pressing rods 103a, 103b, two locking pieces 102a, 102b, and two rotation prevention members 104a, 104b in the embodiment shown, the invention is not limited to this. Rather, the lock 100 may has only one pressing rod, one locking piece, and one rotation prevention member, or three or more pressing rods, three or more locking pieces, and three or more rotation prevention members.

As shown in FIGS. 2-4, the housing 200 includes chambers 203a, 203b positioned side-by-side, and recesses 204a, 204b positioned between the chambers 203a, 203b and separated by a wall 204c. Each recess 204a, 204b includes a pair of facing wall surfaces 201a, 201b, which are substantially parallel to the longitudinal direction Y and the vertical direction Z. The chambers 203a, 203b can receive the two terminals 300a, 300b, respectively, and external cables (not shown) are inserted through the cable passages 105a, 105b of the lock 100 into the housing 200 and electrically connected to the terminals 300a, 300b.

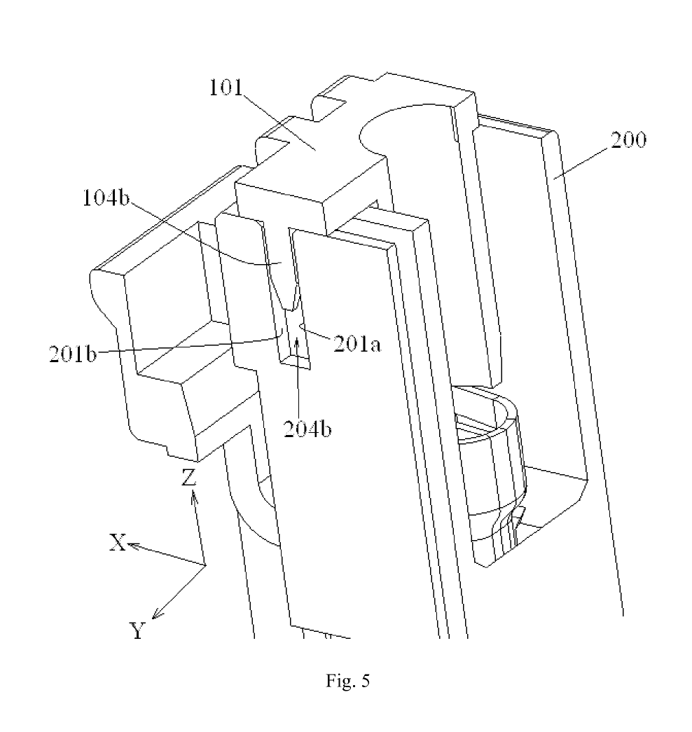

Referring to FIGS. 3-6, the lock 100 is securable to the housing 200 in a snap-fit manner. The two pressing rods 103a, 103b of the lock 100 are insertable into the receiving chambers 203a, 203b of the housing 200 and press against ends of the terminals 300a, 300b, so that the terminals 300a, 300b are firmly secured in the housing 200. Each rotation prevention members 104a, 104b is received by the recesses 204a, 204b, such that the rotation prevention members 104a, 104b are positioned between the pair of facing wall surfaces 201a, 201b in a substantially gapless or tightly contact manner.

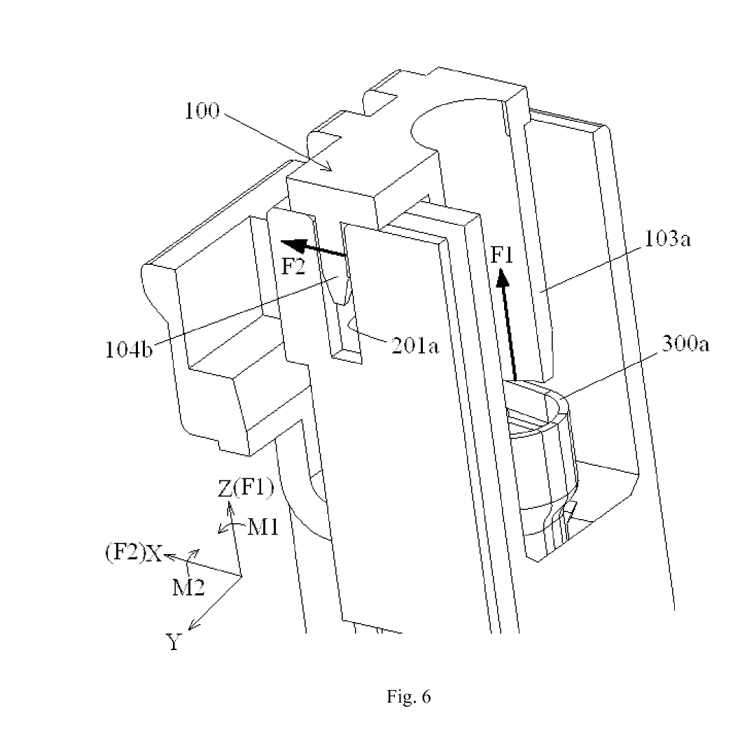

Accordingly, when the cable inserted into one of the cable passage 105a, 105b is pulled outward in the direction Z, a pulling force F1 or a rotation moment M1 is exerted on the pressing rod 103a or 103b of the lock 100 through the cable as shown in FIG. 6. Meanwhile, the rotation prevention members 104a, 104b each tightly abuts against the pair of facing wall surfaces 201a, 201b of the respective recess 204a, 204b in a substantially gapless manner, a reaction force F2 or a reaction rotation moment M2 opposed to the rotation moment M1 is exerted on the rotation prevention members 104a, 104b of the lock 100 using the pair of facing wall surfaces 201a, 201b of the recesses 204a, 204b as shown in FIG. 6. In this way, the rotation moment M1 exerted on the pressing rods 103a, 103b is offset by the reaction rotation moment M2 exerted on the rotation prevention members 104a, 104b and is not transmitted to the locking pieces 102a, 102b of the lock 100. That is to say, since the rotation prevention members 104a, 104b each tightly abuts against the pair of facing wall surfaces 201a, 201b of the respective recess 204a, 204b in a substantially gapless manner, the lock 100 is prevented from being offset from or rotated with respect to the direction Z. Accordingly, the invention can effectively protect the locking pieces 102a, 102b from being damaged under the rotation moment M1.

Furthermore, as shown in FIGS. 1-2 and 5, in another shown embodiment of the invention, the two rotation prevention members 104a, 104b are separated by a gap 104c there between, and the two recesses 204a, 204b are separated by the wall 204c there between. When the lock 100 is mounted to the housing 200 in a snap-fit manner, the wall 204c between the two recesses 204a, 204b is mated with the gap 104c between the two rotation prevention members 104a, 104b in a substantially gapless or tightly contact manner. In this way, it can further prevent the lock 100 from being overturned outward.

In addition, as shown in FIGS. 1-2, in another shown embodiment of the invention, the rotation prevention members 104a, 104b each has a length in the vertical direction Y less than that of the locking piece 102a, 102b in the vertical direction Y, which can increases the anti-bending strength of the rotation prevention members 104a, 104b. However, the invention is not limited to this, the rotation prevention members 104a, 104b may be thickened to increase the anti-bending strength.

Although several shown embodiments have been illustrated and described, it would be appreciated by those skilled in the art that various changes or modifications may be made in these embodiments without departing from the principles and spirit of the disclosure, the scope of which is defined in the claims and their equivalents.

As used herein, an element recited in the singular and proceeded with the word “a” or “an” should be understood as not excluding plural of said elements or steps, unless such exclusion is explicitly stated. Furthermore, references to “one embodiment” of the invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

What is claimed is:

1. An electrical connector comprising:
a housing having a first receiving chamber and first recess positioned adjacent to the first receiving chamber;
a first terminal insertable into the first receiving chamber; and
a lock securable to the housing and having:
a horizontal base plate;
a first pressing rod extending downward from the horizontal base plate and insertable into the first receiving chamber to urge the first terminal; and
a first rotation prevention member extending downward from the horizontal base plate and insertable into the first recess to mate with the recess in a substantially gapless manner.

2. The electrical connector according to claim 1, wherein the lock further includes a first locking piece extending downward from the horizontal base plate and separated from the first pressing rod.

3. The electrical connector according to claim 2, wherein the housing further includes a first slot separated from the first receiving chamber.

4. The electrical connector according to claim 3, wherein the first locking piece snap fits into the first slot.

5. The electrical connector according to claim 4, wherein the first rotation prevention member is positioned between the first pressing rod and the first locking piece.

6. The electrical connector according to claim 5, wherein the first recess includes a pair of facing wall surfaces positioned substantially parallel to each other.

7. The electrical connector according to claim 6, wherein the first rotation prevention member is mated with the pair of facing wall surfaces in a substantially gapless manner when the first rotation prevention member is positioned in the first recess.

8. The electrical connector according to claim 7, wherein the lock further includes a second rotation prevention member separated from the first rotation prevention member by a gap there between.

9. The electrical connector according to claim 8, wherein the housing includes a second recesses separated from the first recess by a wall there between.

10. The electrical connector according to claim 9, wherein the wall is insertable into the gap.

11. The electrical connector according to claim 10, wherein the lock further includes a second pressing rod extending from the horizontal base plate and separately arranged from the first pressing rod.

12. The electrical connector according to claim 11, wherein the lock further includes a second locking piece extending from the horizontal base plate and separately arranged from the first locking piece and the second pressing rod.

13. The electrical connector according to claim 12, wherein the first rotation prevention member has a length less than a length of the first locking piece.

14. The electrical connector according to claim 1, wherein the housing further includes a second receiving chamber positioned adjacent to the first receiving chamber with the first recess positioned between the first receiving chamber and the second receiving chamber.

15. The electrical connector according to claim 14, wherein the housing further includes a second recess positioned adjacent to the first recess between the first receiving chamber and the second receiving chamber.

16. The electrical connector according to claim 15, wherein the housing further includes a wall positioned between the first recess and the second recess.

17. The electrical connector according to claim 16, wherein the lock further includes a second pressing rod extending downward from the horizontal base plate and insertable into the second receiving chamber.

18. The electrical connector according to claim 17, wherein the lock further includes a second rotation prevention member extending downward from the horizontal base plate and insertable into the second recess.

19. The electrical connector according to claim 18, wherein the first rotation prevention member is separated from the second rotation prevention member by a gap there between.

20. The electrical connector according to claim 19, wherein the wall is insertable into the gap.

21. The electrical connector according to claim 20, wherein the lock further includes a second locking piece extending downward from the horizontal base plate and separated from the second pressing rod and the second rotation prevention member.

22. The electrical connector according to claim 1, wherein the first pressing rod has a semi cylindrical shape.
